(19) United States
(12) Patent Application Publication
(10) Pub. No.: US 2018/0085757 A1
(43) Pub. Date: Mar. 29, 2018

(54) DROPLET EJECTING APPARATUS

(71) Applicant: TOSHIBA TEC KABUSHIKI KAISHA, Tokyo (JP)

(72) Inventors: Shuhei YOKOYAMA, Mishima Shizuoka (JP); Satoshi KAIHO, Yokohama Kanagawa (JP); Seiya SHIMIZU, Numazu Shizuoka (JP)

(21) Appl. No.: 15/685,891

(22) Filed: Aug. 24, 2017

(30) Foreign Application Priority Data
Sep. 23, 2016 (JP) 2016-185049

(51) Int. Cl. B01L 3/00

(52) U.S. Cl. CPC B01L 3/52; B01L 2400/0487; B01L 2200/12; B01L 2200/16; B01L 2300/0829

(57) ABSTRACT

A droplet ejecting apparatus includes a solution holding container having a solution inlet on a first surface for receiving a solution and a solution outlet on a second surface opposite to the first surface, solution-contacting inner surfaces of the solution holding container between the solution outlet and the solution inlet having a convex-curved shape, a nozzle fluidly connected to the solution outlet via a pressure chamber, and an actuator adjacent the nozzle and configured to cause solution to be ejected from the nozzle by changing pressure inside the pressure chamber.

### CROSS-REFERENCE TO RELATED APPLICATION

This application is based upon and claims the benefit of priority from Japanese Patent Application No. 2016-185049, filed Sep. 23, 2016, the entire contents of which are incorporated herein by reference.

### FIELD

Embodiments described herein relate generally to a droplet ejecting apparatus.

### BACKGROUND

Fluid dispensing in a range of picoliters (pL) to microliters (μL) is often used in biological and pharmaceutical research and development, medical diagnosis and examination, or agricultural testing. For example, in studying a dose-response effect of chemotherapy, fluid dispensing with a low volume is an important task for determining the concentration of a candidate compound required to effectively attack cancer cells.

In such dose-response experiments, candidate compounds are prepared at many different concentrations in the wells of a multi-well plate to determine an effective concentration. An existing on-demand type droplet ejecting apparatus is used for the above application. For example, the droplet ejecting apparatus includes a solution holding container that holds a solution, a nozzle that ejects the solution, a pressure chamber that is disposed between the solution holding container and the nozzle, and an actuator that controls pressure of the solution inside the pressure chamber to eject the solution from the nozzle.

In the droplet ejecting apparatus, the volume of one droplet ejected from an individual nozzle is on the order of a picoliter (pL). By controlling the total number of droplets ejected into each well, the droplet ejecting apparatus supplies an amount of fluid in a range of picoliters to microliters into each well. Therefore, the droplet ejecting apparatus is generally suitable for a representative task in the dose-response experiments when dispensing the candidate compounds at various concentrations or when dispensing in very small amounts.

### BRIEF DESCRIPTION OF THE DRAWINGS

FIG. 1 is a schematic perspective view of a solution dropping apparatus equipped with a droplet ejecting apparatus according to a first embodiment.

FIG. 2 is a top view of a droplet ejecting apparatus.

FIG. 3 is a bottom view of a droplet ejecting apparatus.

FIG. 4 is a longitudinal sectional view of a droplet ejecting apparatus, taken along line F4-F4 in FIG. 2.

FIG. 5 is a plan view of a droplet ejecting array of a droplet ejecting apparatus.

FIG. 6 is a longitudinal sectional view of the droplet ejecting apparatus, taken along line F6-F6 in FIG. 5.

FIG. 7 is a longitudinal sectional view of a peripheral structure of a nozzle in a droplet ejecting apparatus.

### DETAILED DESCRIPTION

A droplet ejecting apparatus includes a solution holding container having a solution inlet on a first surface for receiving a solution and a solution outlet on a second surface opposite to the first surface, solution-contacting inner surfaces of the solution holding container between the solution outlet and the solution inlet having a convex-curved shape, a nozzle fluidly connected to the solution outlet via a pressure chamber, and an actuator adjacent the nozzle and configured to cause solution to be ejected from the nozzle by changing pressure inside the pressure chamber.

Hereinafter, embodiments will be described with reference to the drawings. Each drawing is a schematic view for illustrating example embodiments and facilitating understanding thereof. The shape, dimension, and ratio of aspects depicted in the drawings may be different from those of an actual apparatus. Furthermore, designs thereof can be changed as appropriate.

Embodiments provide a droplet ejecting apparatus which reduces an amount of solution that remains on an inner wall of a solution holding container and thus reducing an amount of solution to be discarded.

When a solution that remains on an inner wall of a solution holding container cannot be supplied to a pressure chamber, the solution is discarded. Especially on a dome-shaped inner wall of a solution holding container, solution is likely to remain on the inner wall of the solution holding container in a form of droplets. Thus, an amount of solution remaining in the solution holding container without being dispensed is likely to further increase, and an extra amount of solution is required to fill the solution holding container to maintain supply of the solution to the pressure chamber. Since solutions, in particular, solutions which are used in dose-response experiments, are often expensive, an increase in a discarded amount of solution leads to a significant increase in cost of the experiments.

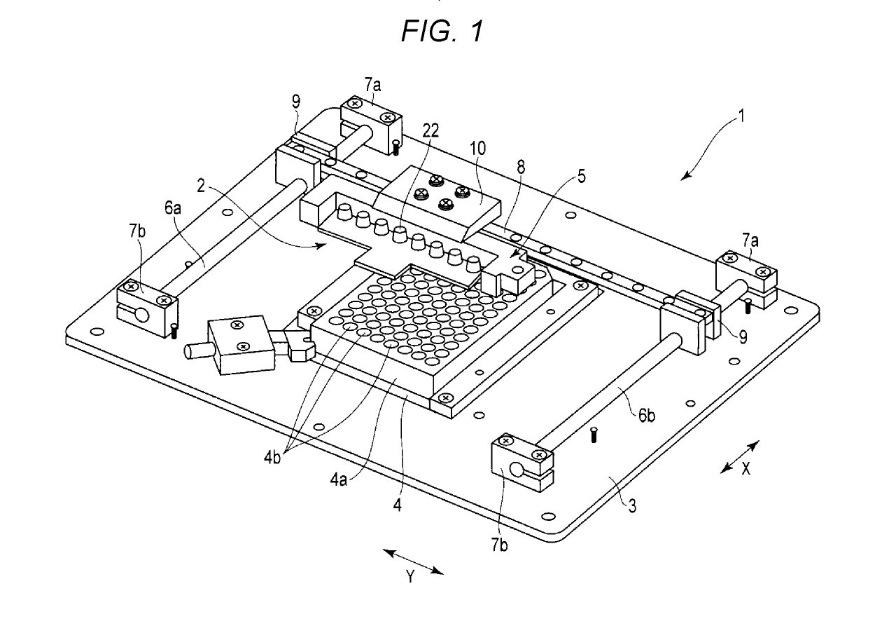

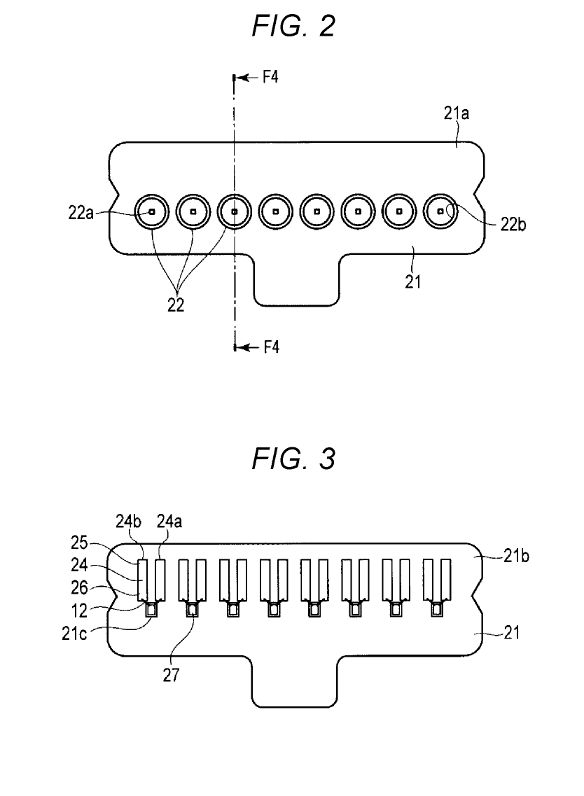

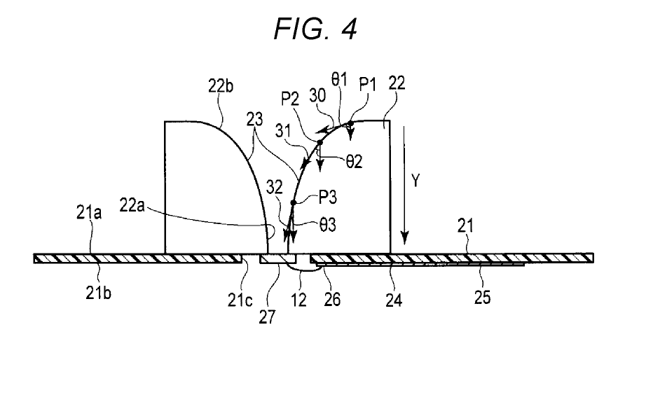

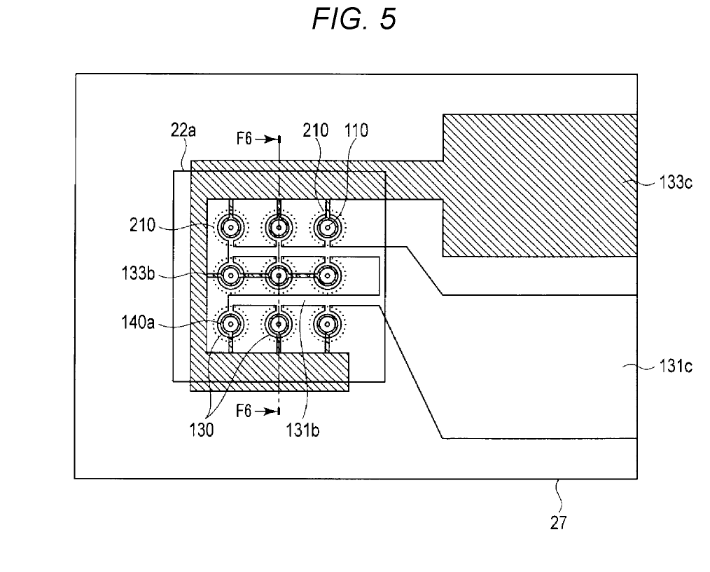

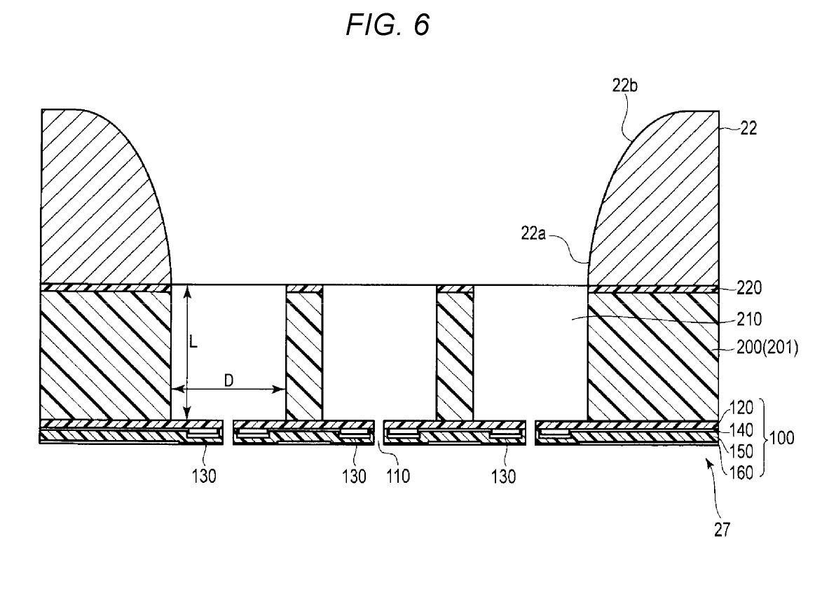

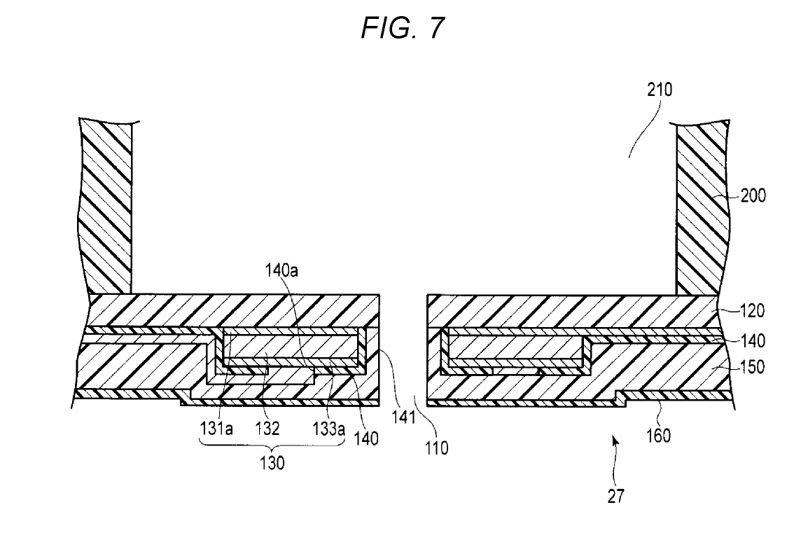

A droplet ejecting apparatus according to an embodiment will be described with reference to FIGS. 1 to 7. FIG. 1 is a perspective view of a solution dropping apparatus 1 including a droplet ejecting apparatus 2. FIG. 2 is a top view of the droplet ejecting apparatus 2. FIG. 3 is a bottom view of a surface of the droplet ejecting apparatus 2 from which droplets are ejected. FIG. 4 is a cross-sectional view taken along line F4-F4 in FIG. 2. FIG. 5 is a plan view of a droplet ejecting array 27 of the droplet ejecting apparatus 2. FIG. 6 is a cross-sectional view taken along line F6-F6 in FIG. 5. FIG. 7 is a longitudinal sectional view illustrating a peripheral structure of a nozzle 110 in the droplet ejecting apparatus 2.

The solution dropping apparatus 1 includes a base 3 having a rectangular flat plate shape and a droplet ejecting apparatus mounting module 5. In the embodiment described herein, a solution is dropped onto a microplate 4 having 96 holes.

The microplate 4 is fixed to the base 3. On either side of the microplate 4 on the base 3, right and left X-direction guide rails 6a and 6b extending in an X-direction are installed. Both end portions of the respective X-direction guide rails 6a and 6b are fixed to fixing bases 7a and 7b protruding on the base 3.

A Y-direction guide rail 8 extending in a Y-direction is installed between the X-direction guide rails 6a and 6b. Both ends of the Y-direction guide rail 8 are respectively fixed to an X-direction moving table 9 which can slide in the X-direction along the X-direction guide rails 6a and 6b.

A Y-direction moving table 10 is disposed on the Y-direction guide rail 8 and can move the droplet ejecting apparatus mounting module 5 in the Y-direction along the Y-direction guide rail 8. The droplet ejecting apparatus mounting module 5 is mounted on the Y-direction moving table 10. The droplet ejecting apparatus 2 is fixed to the droplet ejecting apparatus mounting module 5. In this manner, an operation of the Y-direction moving table 10 moving in the Y-direction along the Y-direction guide rail 8 can be combined with an operation of the X-direction moving table 9 moving in the X-direction along the X-direction guide rails 6a and 6b. Accordingly, the droplet ejecting apparatus 2 is supported so as to be movable to any position in XY-directions which are orthogonal to each other.

The droplet ejecting apparatus 2 has a flat plate-shaped electrical board 21. As illustrated in FIG. 2, a plurality of (e.g., eight in the embodiment described herein) solution holding containers 22 are aligned along the Y-direction on a front surface side, also referred to as first surface 21a, of the electrical board 21. As illustrated in FIG. 4, the solution holding container 22 has a recessed shape whose upper surface is open. A lower surface opening 22a, which serves as a solution outlet at the center position, is formed in a bottom portion of the solution holding container 22. An opening area of an upper surface opening 22b is larger than an opening area of the lower surface opening 22a serving as the solution outlet.

As illustrated in FIG. 4, inner wall surfaces of the solution holding container 22 have a substantially Y-shaped cross-sectional shape having a large opening area toward the upper surface opening 22b side and having a small opening area toward the lower surface opening 22a side. The inner wall surfaces of the solution holding container 22 are provided with solution guide surfaces 23 which are curved to have a convex-curved shape. Tangent lines to the curved surface of the solution guide surface 23 are defined as tangent lines 30, 31, and 32 at an upper position P1, an intermediate position P2, and a lower position P3, respectively, in a vertical direction in FIG. 4 from the upper surface opening 22b to the opening 22a at the bottom portion of the solution holding container 22. Angles θ between an ejecting direction Y of the solution and the tangent lines 30, 31, and 32 are angles θ1, θ2, and θ3, respectively. The curved surface of the solution guide surface 23 of the solution holding container 22 of the droplet ejecting apparatus 2 has the angles θ1, θ2, and θ3 of the tangent lines 30, 31, and 32 which gradually decrease from the upper surface opening 22b to the lower surface opening 22a at the bottom portion of the solution holding container 22 (i.e., θ1>θ2>θ3).

As illustrated in FIG. 3, a rectangular opening 21c which is a through-hole having a larger diameter than the lower surface opening 22a serving as the solution outlet of the solution holding container 22 is formed in the electrical board 21. As illustrated in FIG. 4, the lower surface opening 22a of the solution outlet of the solution holding container 22 is positioned in the opening 21c of the electrical board 21, and the bottom portion of the solution holding container 22 is bonded and fixed to the first surface 21a of the electrical board 21.

An electrical board wiring 24 is patterned on a rear surface side, also referred to as a second surface 21b, of the electrical board 21. The electrical board wiring 24 has two wiring patterns 24a and 24b formed to be respectively connected to a terminal portion 131c of a lower electrode 131 and a terminal portion 133c of an upper electrode 133.

One end portion of the electrical board wiring 24 has a control signal input terminal 25 for inputting a control signal from an external drive circuit. The other end portion of the electrical board wiring 24 includes an electrode terminal connector 26. The electrode terminal connector 26 is connected to the lower electrode terminal portion 131c and the upper electrode terminal portion 133c which are formed in the droplet ejecting array 27 illustrated in FIG. 5.

A droplet ejecting array 27 illustrated in FIG. 4 is bonded and fixed onto the lower surface of the solution holding container 22 so that the droplet ejecting array 27 covers the lower surface opening 22a of the solution holding container 22. The droplet ejecting array 27 is disposed at a position corresponding to the opening 21c in the electrical board 21.

As illustrated in FIG. 6, the droplet ejecting array 27 has a nozzle plate 100 and a pressure chamber structure 200 which are stacked on each other. The nozzle plate 100 has a plurality of nozzles 110 for ejecting the solution, a lower electrode wiring portion 131b and the terminal portion 131c, and an upper electrode wiring portion 133b and the terminal portion 133c. As illustrated in FIG. 5, according to the embodiment described herein, the plurality of nozzles 110 are arranged in 3 by 3 rows.

As illustrated in FIG. 7, the nozzle plate 100 includes a drive element 130 serving as a drive unit, a protective film 150 serving as a protective layer, and a fluid repellent film 160, on a diaphragm 120. The actuator corresponds to the diaphragm 120 and the drive element 130. In some embodiments, the diaphragm 120 may be integrated with the pressure chamber structure 200. For example, when the chamber structure 200 is manufactured on a silicon wafer 201 by a heat treatment in an oxygen atmosphere, a SiO₂ (silicon oxide) film is formed on a surface of the silicon wafer 201. The diaphragm 120 may be the SiO₂ (silicon oxide) film of the surface of the silicon wafer 201 formed by the heat treatment in the oxygen atmosphere. The diaphragm 120 may be formed using a chemical vapor deposition (CVD) method by depositing the SiO₂ (silicon oxide) film on the surface of the silicon wafer 201.

It is preferable that the film thickness of the diaphragm 120 is within a range of 1 to 30 μm. The diaphragm 120 may be of a semiconductor material such as a SiN (silicon nitride) or Al₂O₃ (aluminum oxide).

The drive element 130 is formed for each of the nozzles 110. The drive element 130 has an annular shape surrounding the nozzle 110. A shape of the drive element 130 is not limited, and may be a C-shape obtained by partially cutting the annular shape, for example. The drive element 130 includes an electrode portion 131a of the lower electrode 131 and an electrode portion 133a of the upper electrode 133, interposing a piezoelectric film 132 serving as a piezoelectric body. The electrode portion 131a, the piezoelectric film 132, and the electrode portion 133a are coaxial with the nozzle 110 and have similar diameters.

The lower electrode 131 includes a plurality of circular electrode portions 131a each coaxial with a corresponding circular nozzle 110. For example, the nozzle 110 may have a diameter of 20 μm, and the electrode portion 131a may have an outer diameter of 133 μm and an inner diameter of 42 μm. As illustrated in FIG. 5, the lower electrode 131 includes a wiring portion 131b which connects the plurality of electrode portions 131a to one another. An end portion of the wiring portion 131b includes a terminal portion 131c. In FIG. 5, the electrode portion 131a of the lower electrode 131 and the electrode portion 133a of the upper electrode 133 are overlaid.

The drive element 130 includes the piezoelectric film 132 formed of a piezoelectric material having the thickness of 2 μm, for example, on the electrode portion 131a of the lower electrode 131. The piezoelectric film 132 may be formed of PZT (Pb(Zr, Ti)O₃: lead titanate zirconate). For example, the piezoelectric film 132 is coaxial with the nozzle 110, and has an annular shape whose outer diameter is 133 μm and inner diameter is 42 μm, which is the same shape as the shape of the electrode portion 131a. The film thickness of the piezoelectric film 132 is set to a range of approximately 1 to 30 μm. For example, the piezoelectric film 132 may be of a piezoelectric material such as PTO (PbTiO₃: lead titanate), PMNT (Pb(Mg_{1/3}Nb_{2/3})O₃—PbTiO₃), PZNT (Pb(Zn_{1/3}Nb_{2/3})O₃—PbTiO₃), ZnO, and AlN.

The piezoelectric film 132 generates polarization in a thickness direction. If an electric field in the direction of the polarization is applied to the piezoelectric film 132, the piezoelectric film 132 expands and contracts in a direction orthogonal to the electric field. In other words, the piezoelectric film 132 contracts or expands in a direction orthogonal to the film thickness.

The upper electrode 133 of the drive element 130 is coaxial with the nozzle 110 on the piezoelectric film 132, and has an annular shape whose outer diameter is 133 μm and inner diameter is 42 μm, which is the same shape as the shape of the piezoelectric film 132. As illustrated in FIG. 5, the upper electrode 133 includes a wiring portion 133b which connects the plurality of the electrode portions 133a to one another. An end portion of the wiring portion 133b includes a terminal portion 133c. If a predetermined voltage is applied to the upper electrode 133, a voltage control signal is applied to the lower electrode 131.

For example, the lower electrode 131 may be formed with a thickness of 0.5 μm by stacking Ti (titanium) and Pt (platinum) using a sputtering method. The film thickness of the lower electrode 131 is in a range of approximately 0.01 to 1 μm. The lower electrode 131 may be of other materials such as Ni (nickel), Cu (copper), Al (aluminum), Ti (titanium), W (tungsten), Mo (molybdenum), Au (gold), and SrRuO₃ (strontium ruthenium oxide). The lower electrode 131 may also be of various stacked metal materials.

The upper electrode 133 is formed of a Pt thin film. The thin film is formed using a sputtering method, and the film thickness is set to 0.5 μm. As other electrode materials of the upper electrode 133, Ni, Cu, Al, Ti, W, Mo, Au, and SrRuO₃ can be used. As another film formation method, vapor deposition and plating can be used. The upper electrode 133 may be of various stacked metal materials. The desirable film thickness of the upper electrode 133 is 0.01 to 1 μm.

The nozzle plate 100 includes the insulating film 140 which insulates the lower electrode 131 and the upper electrode 133 from each other. For example, SiO₂ (silicon oxide) having the thickness of 0.5 μm is used for the insulating film 140. In a region proximate to the drive element 130, the insulating film 140 covers the periphery of the electrode portion 131a, the piezoelectric film 132, and the electrode portion 133a. The insulating film 140 covers the wiring portion 131b of the lower electrode 131. The insulating film 140 covers the diaphragm 120 in the region proximate to the wiring portion 133b of the upper electrode 133. The insulating film 140 includes a contact portion 140a which electrically connects the electrode portion 133a and the wiring portion 133b of the upper electrode 133 to each other.

The nozzle plate 100 includes the protective film 150 formed of polyimide, for example, which protects the drive element 130. The protective film 150 includes a cylindrical solution passage 141 communicating with the nozzle 110 in the diaphragm 120. The solution passage 141 has the diameter of 20 μm which is the same as the diameter of the nozzle 110 in the diaphragm 120.

The protective film 150 may be of other insulating materials such as other resins or ceramics. Examples of other resins include ABS (acrylonitrile butadiene styrene), polyacetal, polyamide, polycarbonate, and polyether sulfone. For example, ceramics include zirconia, silicon carbide, silicon nitride, and silicon oxide. The film thickness of the protective film 150 is in a range of approximately 0.5 to 50 μm.

For selecting the material for the protective film 150, the following factors are considered such as the Young's modulus, heat resistance, insulation quality, which determines influence of solution deterioration due to contact with the upper electrode 133 when the drive element 130 is driven in a state of using a highly conductive solution, the coefficient of thermal expansion, smoothness, and wettability to solution being dispensed.

The nozzle plate 100 includes a fluid repellent film 160 which covers the protective film 150. The fluid repellent film 160 is formed, for example, by spin-coating a silicone resin so as to have a property of repelling a solution. The fluid repellent film 160 can be formed of a material, such as a fluorine-containing resin. The thickness of the fluid repellent film 160 is in a range of approximately 0.5 to 5 μm.

The pressure chamber structure 200 is formed using silicon wafer 201 having the thickness of 525 μm, for example. The pressure chamber structure 200 includes a warp reduction film 220 serving as a warp reduction layer on a surface opposite to the diaphragm 120. The pressure chamber structure 200 includes a pressure chamber 210 which penetrates the warp reduction film 220, reaches a position of the diaphragm 120, and communicates with the nozzle 110. The pressure chamber 210 is formed in a circular shape having the diameter of 190 μm which is located coaxially with the nozzle 110, for example. The shape and size of the pressure chamber 210 are not limited.

However, in the embodiment described herein, the pressure chamber 210 includes an opening which communicates with the opening 22a of the solution holding container 22. It is preferable that a size L in a depth direction of the pressure chamber 210 is larger than a size D in a width direction of the opening of the pressure chamber 210. Accordingly, due to the oscillation of the diaphragm 120 of the nozzle plate 100, the pressure applied to the solution contained in the pressure chamber 210 is delayed in escaping to the solution holding container 22.

A side on which the diaphragm 120 of the pressure chamber 210 is disposed is referred to as a first surface of the pressure chamber structure 200, and a side on which the warp reduction film 220 is disposed is referred to a second surface of the pressure chamber structure 200. The solution holding container 22 is bonded to the warp reduction film 220 side of the pressure chamber structure 200 by using an epoxy adhesive, for example. The pressure chamber 210 of the pressure chamber structure 200 communicates with the lower surface opening 22a of the solution holding container 22 through the opening on the warp reduction film 220 side. An opening area of the lower surface opening 22a is larger than a total area of openings of the pressure chambers 210 formed in the droplet ejecting array 27 connecting to the lower surface opening 22a of the solution holding container 22. Therefore, all of the pressure chambers 210 formed in the droplet ejecting array 27 communicate with the lower surface opening 22a of the solution holding container 22.

For example, the warp reduction film 220 is formed in such a way that the silicon wafer 201 is subjected to heat treatment in an oxygen atmosphere, and employs the SiO₂ (silicon oxide) film having a thickness of 4 μm which is formed on the surface of the silicon wafer 201. The warp reduction film 220 may also be formed by depositing a SiO₂ (silicon oxide) film on the surface of the silicon wafer 201 using a chemical vapor deposition method (CVD method). The warp reduction film 220 reduces warp occurring in the droplet ejecting array 27.

The warp reduction film 220 is on the side opposite to the side where the diaphragm 120 is formed on the silicon wafer 201. The warp reduction film 220 reduces the warp of the silicon wafer 201 which is caused by a difference in film stress between the pressure chamber structure 200 and the diaphragm 120 and further a difference in film stress between various configuration films of the drive element 130. The warp reduction film 220 reduces the warp of the droplet ejecting array 27 if the droplet ejecting array 27 is prepared using a deposition process.

The material and the film thickness of the warp reduction film 220 may be different from those of the diaphragm 120. However, if the warp reduction film 220 employs the material and the film thickness which are the same as those of the diaphragm 120, the difference in the film stress between the diaphragms 120 on both sides of the silicon wafer 201 is the same as the difference in the film stress between the warp reduction films 220. If the warp reduction film 220 employs the material and the film thickness which are the same as those of the diaphragm 120, the warp occurring in the droplet ejecting array 27 is more effectively reduced.

The diaphragm 120 is deformed in the thickness direction by the operation of the drive element 130 having a planar shape. The droplet ejecting apparatus 2 ejects the solution supplied to the nozzle 110 due to a pressure change in the pressure chamber 210 of the pressure chamber structure 200 which is caused by the deformation of the diaphragm 120.

An example of a manufacturing method of the droplet ejecting array 27 will be described. In the droplet ejecting array 27, the SiO₂ (silicon oxide) film is first formed on both entire surfaces of the silicon wafer 201 for forming the pressure chamber structure 200. The SiO₂ (silicon oxide) film formed on one surface of the silicon wafer 201 is used as the diaphragm 120. The SiO₂ (silicon oxide) film formed on the other surface of the silicon wafer 201 is used as the warp reduction film 220.

For example, the SiO₂ (silicon oxide) films are formed on both surfaces of the disc-shaped silicon wafer 201 using a thermal oxidation method in which heat treatment is performed in an oxygen atmosphere using a batch type reaction furnace. Next, the plurality of nozzle plates 100 and pressure chambers 210 are formed on the disc-shaped silicon wafer 201 using a deposition process. After the nozzle plate 100 and the pressure chamber 210 are formed, the disc-shaped silicon wafer 201 is cut and separated into the plurality of pressure chamber structures 200 integrated with the nozzle plate 100. The plurality of droplet ejecting arrays 27 can be mass-produced at once using the disc-shaped silicon wafer 201. The silicon wafer 201 may not have a disc shape. A rectangular silicon wafer 201 may be used so as to separately form the nozzle plate 100 and the pressure chamber structure 200 which are integrated with each other.

The diaphragm 120 formed on the silicon wafer 201 is patterned using an etching mask so as to form the nozzle 110. The patterning may use a photosensitive resist as a material of the etching mask. After the photosensitive resist is coated on the surface of the diaphragm 120, exposure and development are performed to form the etching mask in which the opening corresponding to the nozzle 110 is provided. The diaphragm 120 is subjected to dry etching from above the etching mask until the dry etching reaches the pressure chamber structure 200 so as to form the nozzle 110. After the nozzle 110 is formed in the diaphragm 120, the etching mask is removed using a stripping solution, for example.

Next, the drive element 130, the insulating film 140, the protective film 150, and the fluid repellent film 160 are formed on the surface of the diaphragm 120 having the nozzle 110 formed therein. In forming the drive element 130, the insulating film 140, the protective film 150, and the fluid repellent film 160, a film deposition process and a patterning process are repeatedly performed. The film deposition process is performed using a sputtering method, a CVD method, or a spin coating method. For example, the patterning is performed in such a way that the etching mask is formed on the films using a photosensitive resist and the etching mask is removed after etching the underlying film(s).

The materials of the lower electrode 131, the piezoelectric film 132, and the upper electrode 133 are stacked on the diaphragm 120 so as to form a film. As the material of the lower electrode 131, a Ti (titanium) film and a Pt (platinum) film are sequentially formed using a sputtering method. The Ti (titanium) and Pt (platinum) films may also be formed using a vapor deposition method or plating.

As the material of the piezoelectric film 132, PZT (Pb(Zr, Ti)O₃: lead titanate zirconate) is deposited on the lower electrode 131 using an RF magnetron sputtering method at the board temperature of 350° C. When the PZT film is subjected to heat treatment at 500° C. for 3 hours after the PZT film is formed, the PZT film can obtain satisfactory piezoelectric performance. The PZT film may also be formed using a chemical vapor deposition (CVD) method, a sol-gel method, an aerosol deposition (AD) method, or a hydrothermal synthesis method.

As the material of the upper electrode 133, the Pt (platinum) film may be deposited on the piezoelectric film 132 using the sputtering method. On the deposited Pt (platinum) film, an etching mask is prepared to leave the lower electrode 131 and the electrode portion 133a of the upper electrode 133 and the piezoelectric film 132. The Pt (platinum) and PZT (Pb (Zr, Ti)O₃: lead titanate zirconate) films are removed by etching from above the etching mask, thereby forming the electrode portion 133a of the upper electrode 133 and the piezoelectric film 132.

Next, the etching mask which leaves the electrode portion 131a of the lower electrode 131, the wiring portion 131b, and the terminal portion 131c is formed on the lower electrode 131 on which the electrode portion 133a of the upper electrode 133 and the piezoelectric film 132 are formed. Etching is performed from above the etching mask, and the Ti (titanium) and Pt (platinum) films are removed so as to form the lower electrode 131.

As the material of the insulating film 140, the SiO₂ (silicon oxide) film is formed on the diaphragm 120 on which the lower electrode 131, the electrode portion 133a of the upper electrode 133, and the piezoelectric film 132 are formed. For example, the SiO₂ (silicon oxide) film may be formed at low temperature using the CVD method so as to obtain satisfactory insulating performance. The formed SiO₂ (silicon oxide) film is patterned so as to form the insulating film 140.

As the material of the wiring portion 133b and the terminal portion 133c of the upper electrode 133, Au (gold) is deposited using the sputtering method on the diaphragm 120 having the insulating film 140 formed thereon. The Au (gold) film may be formed using the vapor deposition method or the CVD method, or plating. The etching mask which leaves the electrode wiring portion 133b and the terminal portion 133c of the upper electrode 133 is prepared on the deposited Au (gold) film. Etching is performed from above the etching mask, the Au (gold) film is removed so as to form the electrode wiring portion 133b and the terminal portion 133c of the upper electrode 133.

A polyimide film which may be the material of the protective film 150 is formed on the diaphragm 120 having the upper electrode 133 formed thereon. The polyimide film is formed in such a way that a solution containing a polyimide precursor is coated on the diaphragm 120 using a spin coating method and thermal curing is performed by baking so as to remove a solvent. The formed polyimide film is patterned so as to form the protective film 150 which exposes the solution passage 141, the terminal portion 131c of the lower electrode 131, and the terminal portion 133c of the upper electrode 133.

A silicone resin film which may be the material of the fluid repellent film 160 is coated on the protective film 150 using a spin coating method, and thermal curing is performed by baking so as to remove the solvent. The formed silicone resin film 160 is then patterned so as to form the fluid repellent film 160 which exposes the nozzle 110, the solution passage 141, the terminal portion 131c of the lower electrode 131, and the terminal portion 133c of the upper electrode 133.

For example, a rear surface protective tape for chemical mechanical polishing (CMP) of the silicon wafer 201 may adhere onto the fluid repellent film 160 as a cover tape so as to protect the fluid repellent film 160, and the pressure chamber structure 200 can be patterned. The etching mask which exposes the pressure chamber 210 with the diameter of 190 μm is formed on the warp reduction film 220 of the silicon wafer 201. First, the warp reduction film 220 is subjected to dry etching using a mixed gas of CF₄ (carbon tetrafluoride) and O₂ (oxygen). Next, for example, vertical deep dry etching preferentially for the silicon wafer is performed using a mixed gas of SF₆ (sulfur hexafluoride) and O₂. The dry etching is stopped at a position in contact with the diaphragm 120, thereby forming the pressure chamber 210 in the pressure chamber structure 200.

The etching for forming the pressure chamber 210 may be performed by a wet etching method using a liquid etchant or a dry etching method using plasma. After the etching is completed, the etching mask is removed. A cover tape adhering onto the fluid repellent film 160 is irradiated with ultraviolet light so as to weaken adhesiveness therebetween, and the cover tape is detached from the fluid repellent film 160. The disc-shaped silicon wafer 201 is diced so as to separately form the plurality of droplet ejecting arrays 27.

Next, a manufacturing method of the droplet ejecting apparatus 2 will be described. The droplet ejecting array 27 is bonded to a solution holding container 22. In this case, the bottom surface on the lower surface opening 22a side of the solution holding container 22 is bonded to the warp reduction film 220 side of the pressure chamber structure 200 in the droplet ejecting array 27.

Thus, a solution holding container 22 having the droplet ejecting array 27 bonded thereto is bonded to the first surface 21a of the electrical board 21 so that the lower surface opening 22a fits inside the opening 21c of the electrical board 21.

Subsequently, the electrode terminal connector 26 and the terminal portion 131c of the lower electrode 131 and the terminal portion 133c of the upper electrode 133 of the droplet ejecting array 27 are connected to each other by wiring 12. A connection method includes a method using a flexible cable. An electrode pad of the flexible cable can be electrically connected to the electrode terminal connector 26. The terminal portion 131c and the terminal portion 133c may be electrically connected via an anisotropic conductive film formed by thermocompression bonding.

The electrical signal input terminal 25 on the electrical board wiring 24 has a shape which can come into contact with a leaf spring connector for inputting a control signal that is output from a control circuit (not illustrated), for example. This forms the droplet ejecting apparatus 2.

Next, an operation of the above-described configuration will be described. The droplet ejecting apparatus 2 is fixed to the droplet ejecting apparatus mounting module 5 of the solution dropping apparatus 1. When the droplet ejecting apparatus 2 is used, a predetermined amount of the solution is first supplied to the solution holding container 22 from the upper surface opening 22b of the solution holding container 22 by a pipette (not illustrated) or the like. The solution is held within the solution holding container 22. The lower surface opening 22a at the bottom portion of the solution holding container 22 communicates with the droplet ejecting arrays 27. Each pressure chamber 210 of the droplet ejecting array 27 is supplied with the solution from the solution holding container 22 via the lower surface opening 22a at the bottom surface of the solution holding containers 22.

In this position, a voltage control signal input to the control signal input terminal 25 is transmitted from the electrode terminal connector 26 to the terminal portion 131c of the lower electrode 131 and the terminal portion 133c of the upper electrode 133. At this time, in response to the voltage control signal applied to the drive element 130, the diaphragm 120 is deformed so as to change the volume of the pressure chamber 210. In this manner, the solution flowing from the nozzle 110 of the droplet ejecting array 27 is ejected as a solution droplet. A predetermined amount of solution is dropped from the nozzle 110 into each well 4b of the microplate 4.

The amount of one droplet ejected from the nozzle 110 is in a range of 2 to 5 picoliters. Therefore, the amount of fluid ejected into each well 4b can be controlled on the order of picoliters (pL) to microliters (μL) by controlling the number of ejected droplets.

In the droplet ejecting apparatus 2, the inner wall surfaces of the solution holding container 22 are provided with the solution guide surfaces 23 which are curved to have a convex-curved shape. On the curved surface of the solution guide surface 23, the angles θ1, θ2, and θ3 of the tangent lines 30, 31, and 32 gradually decrease from the upper surface opening 22b to the lower surface opening 22a at the bottom portion of the solution holding container 22 (i.e., θ1>θ2>θ3). Therefore, the solution in the solution holding container 22 is smoothly guided along the solution guide surface 23 toward the bottom portion of the solution holding container 22, and thus it is possible to reduce an amount of solution remaining on the inner walls of the solution holding container 22. In this manner, the solution in the solution holding container 22 is supplied to the pressure chamber 210 without remaining on the inner wall of the solution holding container 22, and thus it is possible to provide the droplet ejecting apparatus 2 that discards only a small amount of solution. The shape of the inner wall of the solution holding container 22 will be described below.

The angles θ1, θ2, and θ3 of the tangent lines 30, 31, and 32 of the curved surface of the solution guide surface 23 gradually decrease from the upper surface opening 22b to the opening 22a at the bottom portion of the solution holding container 22 (θ1>θ2>θ3). As a result, when an amount of solution remaining in the solution holding container 22 is reduced through the ejection of the solution, the angles of the tangent lines of the inner wall of the solution holding container 22, with which the solution comes into contact, decreases from the angle θ1 through the angle θ2 to the angle θ3. Therefore, the amount of solution remaining on the inner wall of the solution holding container 22 is reduced, and thereby it is possible to provide a droplet ejecting apparatus 2 that wastes only a small amount of solution.

When the solution is ejected to each well 4b of the microplate 4, the amount of solution in the solution holding container 22 decreases as the solution is being ejected, and a surface of the solution approaches the lower surface opening 22a at the bottom portion of the solution holding container 22. However, with this inner wall shape of the solution holding container 22, as the amount of solution in the solution holding container 22 is reduced, an amount of change in the position of the surface of the solution in the solution holding container 22 is increased. Therefore, a small amount of solution remains visible in the solution holding container 22, and thus the solution can be prevented from being depleted in the solution holding container 22.

According to the embodiment, it is possible to provide a droplet ejecting apparatus 2 that reduces an amount of solution remaining on the inner wall of the solution holding container 22 and thus wastes only a small amount of solution.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the drive element 130 serving as a drive unit has a circular shape. However, the shape of the drive unit is not limited to a circular shape. The shape of the drive unit may be a rhombus shape or an elliptical shape, for example. Similarly, the shape of the pressure chamber 210 is not limited to a circular shape, and may be a rhombus shape or the elliptical shape, or a rectangular shape.

In the example embodiments, the nozzle 110 is disposed at the center of the drive element 130. However, the position of the nozzle 110 is not particularly limited as long as the solution of the pressure chamber 210 can be ejected from the nozzle 110. For example, the nozzle 110 may be formed outside the drive element 130, that is, not within an overlapping region of the drive element 130. If the nozzle 110 is disposed outside the drive element 130, the nozzle 110 does not need to be patterned by penetrating a plurality of film materials of the drive element 130. Likewise, the he plurality of film materials of the drive element 130 do not need an opening patterning process to be performed at the position corresponding to the nozzle 110. The nozzle 110 can be formed by simply patterning the diaphragm 120 and the protective film 150. Therefore, the patterning process may be facilitated.

What is claimed is:

1. A droplet ejecting apparatus, comprising:
a solution holding container having a solution inlet on a first surface for receiving a solution and a solution outlet on a second surface opposite to the first surface, solution-contacting inner surfaces of the solution holding container between the solution outlet and the solution inlet having a convex-curved shape;
a nozzle fluidly connected to the solution outlet via a pressure chamber; and
an actuator adjacent the nozzle and configured to cause solution to be ejected from the nozzle by changing pressure inside the pressure chamber.

2. The droplet ejecting apparatus according to claim 1, wherein a solution ejection direction of the nozzle is orthogonal to the second surface.

3. The droplet ejecting apparatus according to claim 1, wherein
an opening area of the solution inlet is larger than an opening area of the solution outlet,
a distance from one opposing solution-contacting inner surface to another opposing solution-contacting inner surface continuously narrows from the solution inlet to the solution outlet.

4. The droplet ejecting apparatus according to claim 3, wherein the solution inlet and the solution outlet are aligned along a first direction orthogonal to the second surface such that a center of the opening area of the solution inlet is above a center of the opening area of the solution outlet in the first direction.

5. The droplet ejecting apparatus according to claim 1, wherein a solution holding space between the solution-contacting inner surfaces of the solution holding container has a Y-shaped cross-section.

6. The droplet ejecting apparatus according to claim 1, wherein an angle between a tangent line of a curved surface of a solution-contacting inner surface and a solution ejection direction of the nozzle continuously decreases from the solution inlet to the solution outlet.

7. The droplet ejecting apparatus according to claim 1, wherein the actuator is a piezoelectric actuator.

8. A droplet ejecting apparatus comprising:
a droplet ejecting array having a pressure chamber and a nozzle from which solution in the pressure chamber is ejected;
an actuator adjacent the nozzle and configured to cause solution to be ejected from the nozzle by changing pressure inside the pressure chamber; and
a solution container having a solution inlet on a first surface for receiving a solution and a solution outlet a second surface opposite to the first surface fluidly connected to the pressure chamber, wherein
a solution holding space in the solution container between solution-contacting inner surfaces of the solution container has a Y-shaped cross-section,
the solution-contacting inner surfaces each having a curved surface portion, and
an angle between a tangent line of the curved surface portion of each solution-contacting inner surface and a solution ejection direction of the nozzle continuously decreases from the solution inlet to the solution outlet.

9. The droplet ejecting apparatus according to claim 8, wherein the solution ejection direction of the nozzle is orthogonal to the second surface.

10. The droplet ejecting apparatus according to claim 8, wherein
an opening area of the solution inlet is larger than an opening area of the solution outlet,
a distance from one opposing solution-contacting inner surface to another opposing solution-contacting inner surface continuously narrows from the solution inlet to the solution outlet.

11. The droplet ejecting apparatus according to claim 10, wherein the solution inlet and the solution outlet are aligned along a first direction orthogonal to the second surface such that a center of the opening area of the solution inlet is above a center of the opening area of the solution outlet in the first direction.

12. The droplet ejecting apparatus according to claim 8, wherein the actuator is a piezoelectric actuator.

13. A solution dispenser, comprising:
a base on which a microplate can be disposed;
a solution holding container having a solution inlet on a first surface for receiving a solution and a solution outlet on a second surface opposite to the first surface, solution-contacting inner surfaces of the solution holding container between the solution outlet and the solution inlet having a convex-curved shape;
a nozzle fluidly connected to the solution outlet via a pressure chamber; and
an actuator adjacent the nozzle and configured to cause solution to be ejected from the nozzle by changing pressure inside the pressure chamber

14. The solution dispenser according to claim 13, wherein the microplate is selected from a 96 well microplate, a 384 well microplate, a 1,536 well microplate, a 3,456 well microplate, and a 6,144 well microplate.

15. The solution dispenser according to claim 13, wherein a solution ejection direction of the nozzle is orthogonal to the second surface.

16. The solution dispenser according to claim 13, wherein
an opening area of the solution inlet is larger than an opening area of the solution outlet,
a distance from one opposing solution-contacting inner surface to another opposing solution-contacting inner surface continuously narrows from the solution inlet to the solution outlet.

17. The solution dispenser according to claim 16, wherein the solution inlet and the solution outlet are aligned along a first direction orthogonal to the second surface such that a center of the opening area of the solution inlet is above a center of the opening area of the solution outlet in the first direction.

18. The solution dispenser according to claim 13, wherein a solution holding space between the solution-contacting inner surfaces of the solution holding container has a Y-shaped cross-section.

19. The solution dispenser according to claim 13, wherein an angle between a tangent line of a curved surface of a solution-contacting inner surface and a solution ejection direction of the nozzle continuously decreases from the solution inlet to the solution outlet.

20. The solution dispenser according to claim 13, wherein the actuator is a piezoelectric actuator.
